(19) United States
(12) Patent Application Publication
(10) Pub. No.: US 2025/0187969 A1
(43) Pub. Date: Jun. 12, 2025

(54) DEVICES FOR PREPARING ULTRA-THIN FLEXIBLE GLASS AND METHODS THEREOF

(71) Applicant: CAIHONG DISPLAY DEVICES CO., LTD., Xianyang (CN)

(72) Inventors: Lingxin KONG, Xianyang (CN); Lihua XU, Xianyang (CN); Jian XU, Xianyang (CN)

(73) Assignee: CAIHONG DISPLAY DEVICES CO., LTD., Xianyang (CN)

(21) Appl. No.: 18/969,200

(22) Filed: Dec. 4, 2024

Related U.S. Application Data
(63) Continuation-in-part of application No. PCT/CN2024/092920, filed on May 13, 2024.

(30) Foreign Application Priority Data
Dec. 6, 2023 (CN) 202311666739.1

(51) Int. Cl. C03B 29/08; C03B 25/04; C03B 35/06; C03B 40/033

(52) U.S. Cl. CPC C03B 29/08; C03B 25/04; C03B 35/06; C03B 40/033

(57) ABSTRACT

Devices for preparing ultra-thin flexible glass and methods are provided. A feeding system, a preheating heating annealing furnace body, an edge clamping system, a drawing system, a laminating system, a winding system, and a cutting system are provided to satisfy overall production of flexible glass. The clamping device clamps two ends of the glass. The glass is drawn at a discharging end and fed at the feeding end, thereby forming a continuous drawing with feeding and drawing. The overall horizontal setting of device avoids high-level operation. The preheating heating annealing furnace body includes a preheating section, a heating section, and an annealing section. The temperature change of the glass is more compact through the gradient temperature control of the heating device. Temperature-measuring points in the preheating heating annealing furnace body are designed in a grid-like manner, which clarifies temperature points of glass blocks, and facilitates temperature adjustment, so that the glass is uniformly heated, and fracture of the glass caused by uneven heating, uneven drawing thickness, or uneven heating and cooling are avoided, thereby ensuring the glass drawing utilization rate and enhancing the utilization rate of the glass plate of uneven thickness.

### CROSS-REFERENCE TO RELATED APPLICATIONS

This application is a continuation-in-part application of International Application No. PCT/CN2024/092920, filed on May 13, 2024, which claims priority to Chinese Patent Application No. 202311666739.1, filed on Dec. 6, 2023, the entire contents of each of which are incorporated herein by reference.

### TECHNICAL FIELD

The present disclosure relates to the field of preparation of ultra-thin flexible glass, and in particular, to devices for preparing ultra-thin flexible glass and methods thereof.

### BACKGROUND

With the rapid development of the display industry, electronic glass, as a key substrate of display products, is constantly becoming large, thin, and light. Flexible glass, which can be rolled and folded like paper, has emerged in this context. Flexible glass maintains the stable physicochemical performance of the glass itself, but also has the performance of good flexibility and high bending strength. Therefore, the flexible glass has a wide application prospect in the fields of flexible displays, ITO conductive film glass substrate, OLED lighting, and flexible thin film solar cells, which becomes one of the most promising materials today and even in the future.

Currently, flexible glass is prepared by float process, overflow process, slot-drawing process, redrawing process, and chemical thinning process. Although the overflow process produces glass with excellent surface quality, the process includes the convergence of molten glass at the overflow brick tip to form a root, and a base thickness of the root increases the difficulty in thinning the glass. The slot-drawing process eliminates the problem of glass root, but the material is limited by the precious metal, and the cost is still high. The float process requires an additional edge-drawing machine and traction rollers to overcome the gravity and surface tension of the molten glass, and the tin-infiltrated layer formed on the lower surface of the glass requires further processing. The chemical thinning process for thinning glass thickness is limited, which has a strict requirement for microcracking state of the substrate, and the chemical thinning reagents (e.g., hydrofluoric acid) has strong corrosive contamination, which brings invisible pressure to the thinning of glass. The redrawing process is the secondary extension of the base material, which has advantages of simple principle, small investment, and small production space. Compared with other preparation processes, the redrawing process is a good choice for the preparation and production of flexible glass.

However, the redrawing process mostly adopts the vertical downdrawing mode, which requires a high configuration for height of the plant, and has the problems of difficult feeding, difficult continuous production, uneven thickness or fracture of glass due to uneven heating, low raw material utilization, and low output.

Therefore, it is desired to provide a device for preparing ultra-thin flexible glass and a method to reduce the problems of uneven thickness caused by uneven heating, thereby improving the utilization rate of glass raw materials.

### SUMMARY

One or more embodiments of the present disclosure provide a device for preparing ultra-thin flexible glass. The device for preparing ultra-thin flexible glass may include a preheating heating annealing furnace body. The preheating heating annealing furnace body may be provided with a feeding system and a drawing system on both sides. An edge clamping system may be disposed from a feeding port to a middle of the preheating heating annealing furnace body. The drawing system may be successively connected with a laminating system, a winding system, and a cutting system. The edge clamping system may include a first clamping device and a second clamping device. The first clamping device and the second clamping device may be each formed by a pressing bar and a pressing bar support. The pressing bar support may be vertically connected to the pressing bar. The pressing bar support may be disposed at a furnace mouth of the preheating heating annealing furnace body, and rollers may be disposed above and below the pressing bar.

In some embodiments, the feeding system may include a feeding drive, a feeding end clamping device, and a feeding guide rail. The feeding drive may be connected to one side of the feeding guide rail, and the feeding end clamping device may be located on the feeding guide rail.

In some embodiments, a central position of the preheating heating annealing furnace body may be in a form of a channel. Two ends of the preheating heating annealing furnace body may be respectively connected to a feeding end and a discharging end. A preheating section, a heating section, and an annealing section may be disposed inside the preheating heating annealing furnace body. A heat insulation plywood may be respectively disposed between the preheating section and the heating section and between the heating section and the annealing section. A cross-sectional area of the heat insulation plywood may be adjustable.

In some embodiments, a heat preservation layer and a refractory fiber adiabatic layer may be disposed outside the preheating heating annealing furnace body.

In some embodiments, the preheating heating annealing furnace body may be provided with a furnace body heating device. The furnace body heating device may include a preheating heating module and a softening heating module. The preheating heating module and the softening heating module may be respectively provided with a plurality of groups of heating wires or heating rods.

In some embodiments, the preheating heating annealing furnace body may be provided with a furnace body temperature control device. The furnace body temperature control device may include a programmable proportion integration differentiation (PID) controller, an ammeter, a voltmeter, and a temperature-measuring thermocouple. The temperature-measuring thermocouple may be distributed in a grid-like manner above a preheating section, a heating section, and an annealing section.

In some embodiments, the drawing system may be connected to an annealing port of the preheating heating annealing furnace body. The drawing system may include a discharging end clamping device, a drawing motion guide rail, a drawing arm, and a tension drive. The discharging end clamping device may be disposed on the drawing motion guide rail. The discharging end clamping device may be connected to the drawing arm. The tension drive may act on the drawing arm to drive glass clamped by the discharging end clamping device through tension, to draw the glass.

In some embodiments, the drawing system may further include a limiter and a tension sensor. The limiter may be located on the drawing arm and move with the drawing arm. The limiter may be configured to limit a moving speed of the drawing arm on the drawing motion guide rail. The tension sensor may be located in the tension drive and configured to monitor the tension of the drawing arm.

In some embodiments, the limiter may be further configured to: in response to a determination that a tension change rate at a plurality of time points obtained by the tension sensor meets a preset change condition, stop moving to limit the drawing arm.

In some embodiments, the laminating system may be configured to electrostatically adsorb a film with a thickness of 0.1 mm-0.5 mm onto two surfaces of glass.

In some embodiments, the film may be selected from a polyethylene film, a polypropylene film, a polyvinyl chloride film, or a polyester film.

In some embodiments, the cutting system may include a cutting knife, a cutting knife drive, and a cutting and dust removal device.

In some embodiments, the edge clamping system may be further connected to an edge cooling device.

One or more embodiments of the present disclosure provide a method for preparing ultra-thin flexible glass. The method may be performed based on the above device for preparing ultra-thin flexible glass. The method may include loading a raw glass sheet into the channel of the preheating heating annealing furnace body, clamping the raw glass sheet by the edge clamping system, preheating the loaded raw glass sheet in the preheating heating annealing furnace body, transmitting the raw glass sheet to the heating section when a preheating temperature is reached, evenly heating the preheated raw glass sheet to a drawing temperature for softening, drawing the softened glass in the drawing system, annealing the drawn glass and transmitting the annealed glass to the laminating system for laminating, transmitting the laminated glass into the winding system for package, and transmitting the packaged glass into the cutting system for rolling according to a fixed roll size.

In some embodiments, the method may be performed by a processor and the method may include generating, based on raw glass sheet thickness data obtained by a thickness monitoring device, thickness sequence data corresponding to the raw glass sheet, and controlling, based on the thickness sequence data, a thickness of the drawn glass by regulating a drawing parameter of the drawing system.

In some embodiments, a data amount of the thickness sequence data may be related to a uniform value of the thickness of the drawn glass that is monitored subsequently.

In some embodiments, the method may further include determining, based on thickness data of each raw glass sheet of the thickness sequence data, a candidate drawing parameter. The candidate drawing parameter may be an input of a drawing model. The drawing model may be a machine learning mode. The drawing model may be configured to determine the drawing parameter. The determining a candidate drawing parameter may include determining, based on the thickness data of each raw glass sheet of the thickness sequence data, at least one reference drawing parameter as a first candidate parameter by retrieving from a vector database, determining, based on the first candidate parameter, a second candidate parameter by interpolation, and determining the candidate drawing parameter based on the first candidate parameter and the second candidate parameter.

In some embodiments, the method may further include pre-regulating, based on thickness sequence data, target temperatures of different regions of the preheating heating annealing furnace body through separate heating groups in the preheating heating annealing furnace body.

In some embodiments, the pre-regulating target temperatures of different regions in the preheating heating annealing furnace body may include regulating the target temperatures of different regions in the preheating heating annealing furnace body by adjusting a cross-sectional area of the heat insulation plywood.

In some embodiments, an overall heating power of the preheating heating annealing furnace body may be related to a uniform value of a thickness of the drawn glass that is monitored subsequently.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a schematic diagram illustrating an exemplary device for preparing ultra-thin flexible glass according to some embodiments of the present disclosure;

FIG. 2 is sectional view of a preheating heating annealing furnace body according to some embodiments of the present disclosure;

FIG. 3 is a sectional view of an edge clamping system according to some embodiments of the present disclosure;

FIG. 4 is a schematic diagram illustrating an edge clamping system according to some embodiments of the present disclosure; and

FIG. 5 is a schematic diagram illustrating another edge clamping system according to some embodiments of the present disclosure.

In the Drawing, 1—feeding system; 2—preheating heating annealing furnace body; 3—edge clamping system; 4—drawing system; 5—laminating system; 6—winding system; 7—cutting system; 11—feeding drive; 12—feeding end clamping device; 13—feeding guide rail; 21—furnace body heating device; 22—temperature-measuring thermocouple; 31—first clamping device; 32—second clamping device; 33—roller; 34—pressing bar; 35—pressing bar support; 41—discharging end clamping device; 42—drawing motion guide rail; 43—drawing arm; 44—tension drive; 45—limiter; and 46—tension sensor.

### DETAILED DESCRIPTION

In order to more clearly illustrate the technical solutions relating to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

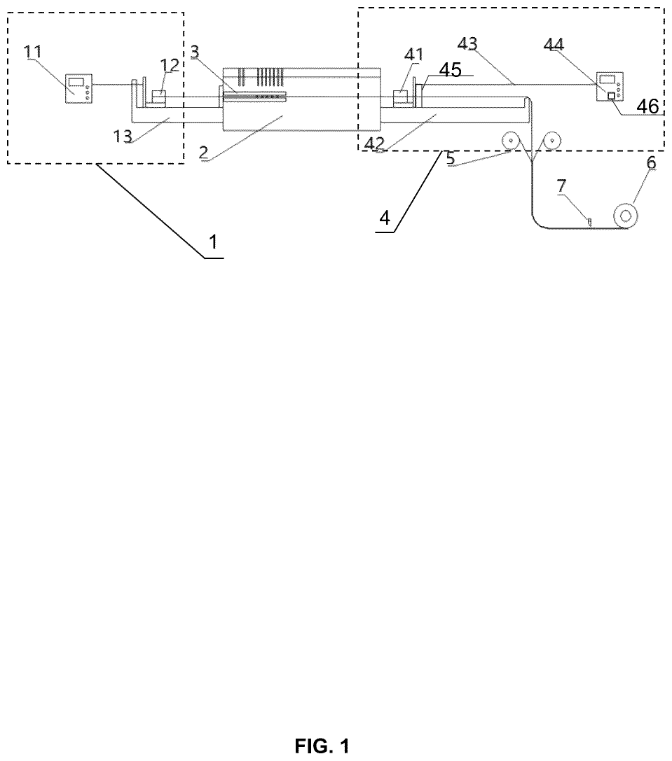

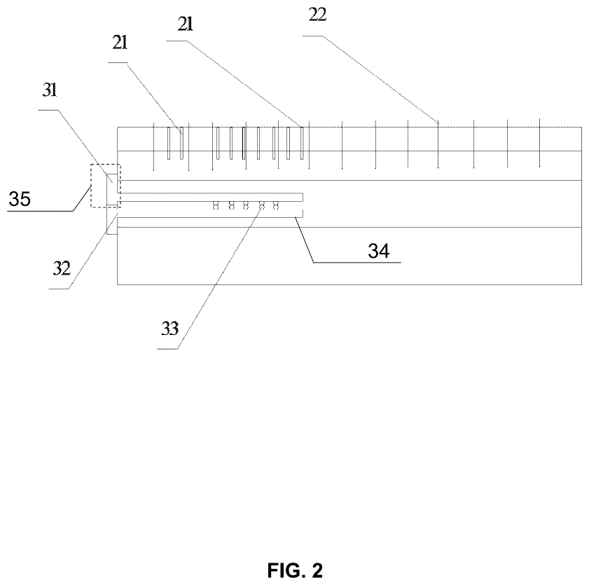

FIG. 1 is a schematic diagram illustrating an exemplary device for preparing ultra-thin flexible glass according to some embodiments of the present disclosure; FIG. 2 is a sectional view of a preheating heating annealing furnace body according to some embodiments of the present disclosure. As shown in FIGS. 1 and 2, the device for preparing ultra-thin flexible glass includes a preheating heating annealing furnace body 2. The preheating heating annealing furnace body 2 is provided with a feeding system 1 and a drawing system 4 on both sides. An edge clamping system 3 is disposed from a feeding port to a middle of the preheating heating annealing furnace body. The drawing system 4 is successively connected with a laminating system 5, a winding system 6, and a cutting system 7. The edge clamping system 3 includes a first clamping device 31 and a second clamping device 32. The first clamping device 31 and the second clamping device 32 are each formed by a pressing bar 34 and a pressing bar support 35. The pressing bar support 35 is vertically connected to the pressing bar 34. The pressing bar support 35 is disposed at a furnace mouth of the preheating heating annealing furnace body 2, and rollers 33 are disposed above and below the pressing bar 34.

The feeding system 1 is configured to feed continuously in a process of preparing the ultra-thin flexible glass. As shown in FIG. 1, the feeding system 1 is connected to the feeding port of the preheating heating annealing furnace body 2. The feeding system 1 may be configured to transmit a raw glass sheet to the preheating heating annealing furnace body 2 for preheating and heating.

In some embodiments, the feeding system 1 includes a feeding drive 11, a feeding end clamping device 12, and a feeding guide rail 13. The feeding drive 11 is connected to one side of the feeding guide rail 13, and the feeding end clamping device 12 is located on the feeding guide rail 13. As shown in FIG. 1, one side of the feeding guide rail 13 connecting the feeding drive 11 is one side of the feeding guide rail 13 away from the preheating heating annealing furnace body 2.

The feeding drive 11 is configured to drive the feeding end clamping device 12 to move along the feeding guide rail 13. The feeding end clamping device 12 is configured to clamp one end of glass, and the glass enters the preheating heating annealing furnace body 2 along the feeding guide rail 13. The feeding drive 11 may be any feasible driving device, for example, the feeding drive 11 includes a motor driving device, a pneumatic driving device, etc. The feeding end clamping device 12 may include two plate-like structures, and the plate-like structures abut against each other from top and bottom to clamp the glass.

Under the driving of the feeding drive 11, the feeding end clamping device 12 may move along the feeding guide rail 13 towards a direction of the preheating heating annealing furnace body 2, thereby feeding the glass clamped by the feeding end clamping device 12 into the preheating heating annealing furnace body 2. The feeding guide rail 13 may be a U-shaped guide rail. A shape of a cross section of the feeding guide rail 13 may be adapted to a shape of the plate structure, so that the feeding end clamping device 12 may move stably in the feeding guide rail 13.

In some embodiments, a scale is disposed on the feeding guide rail 13. By determining a position of the feeding end clamping device 12 on the scale of the feeding guide rail 13, a feeding displacement may be determined, which helps to adjust a feeding rate. The feeding displacement refers to a length of feeding.

In some embodiments of the present disclosure, the feeding end clamping device 12 and the feeding guide rail 13 may transmit the glass to the preheating heating annealing furnace body 2 through the feeding drive 11, which helps to continuously feed the glass in the process of preparing the ultra-thin flexible glass.

The preheating heating annealing furnace body 2 is configured to preheat, heat, and anneal the glass. In some embodiments, a hollow channel for holding the glass may be disposed inside the preheating heating annealing furnace body 2. One end of the hollow channel is connected to a feeding port and the other end of the hollow channel is connected to a discharging port. The feeding system 1 may feed the glass into the hollow channel through the feeding port.

In some embodiments, a central position of the preheating heating annealing furnace body 2 is in a form of a channel. Two ends of the preheating heating annealing furnace body are respectively connected to a feeding end and a discharging end. A heat preservation layer and a refractory fiber adiabatic layer are disposed outside the preheating heating annealing furnace body 2. The heat preservation layer may be a layered structure made of heat preservation material (e.g., silicon carbide fibers, alumina, etc.). The refractory fiber adiabatic layer may be a layered structure made of refractory adiabatic material (e.g., dolomite, bauxite, etc.).

A preheating section, a heating section, and an annealing section may be disposed inside the preheating heating annealing furnace body 2. A heat insulation plywood is respectively disposed between the preheating section and the heating section and between the heating section and the annealing section. A cross-sectional area of the heat insulation plywood in the channel is adjustable.

The preheating section refers to a region of the preheating heating annealing furnace body 2 configured to preheat the glass. The heating section refers to a region of the preheating heating annealing furnace body 2 configured to soften and heat the glass. The annealing section refers to a region of the preheating heating annealing furnace body 2 configured to anneal the glass. The preheating section is adjacent to the heating section, and the preheating section is near the feeding end. The heating section is adjacent to the annealing section, and the annealing section is near the discharging end. The heating section is located between the preheating section and the annealing section.

The heat insulation plywood is used to insulate between the preheating section and the heating section and between the heating section and the annealing section.

The heat insulation plywood may be of a plate-like structure. One side of the heat insulation plywood is fixed to the channel of the preheating heating annealing furnace body 2, and the other side of the heat insulation plywood is moved by a driving device (e.g., a mechanical arm). By adjusting a position of the movable side of the heat insulation plywood through the driving device (e.g., the mechanical arm), the cross-sectional area of the heat insulation plywood in the channel may be adjusted. The heat insulation plywood may be made of heat insulation material such as fiberglass, vacuum board, etc.

The preheating heating annealing furnace body 2 is provided with a furnace body heating device 21. The furnace body heating device 21 includes a preheating heating module and a softening heating module. The preheating heating module and the softening heating module are respectively provided with a plurality of groups of heating wires or heating rods.

The furnace body heating device 21 refers to a heating device of the preheating heating annealing furnace body 2. The furnace body heating device 21 is configured to heat the preheating heating annealing furnace body 2.

The preheating heating module may heat the preheating section of the preheating heating annealing furnace body 2 to a temperature required for preheating the glass. The softening heating module may heat the heating section of the preheating heating annealing furnace body 2 to a temperature required for softening the glass. The preheating heating module may be located in the preheating section, and the softening heating module may be located in the heating section.

A heating state of each group of heating wires or a heating state of each group of heating rods in the preheating heating module and the softening heating module may be independently adjusted to regulate a temperature of the preheating section and a temperature of the heating section. For example, a temperature of each group of heating wires or a temperature of each group of heating rods in the preheating heating module may be independently adjusted based on a distance between the heating wires or the heating rods and the feeding end. The larger the distance between the heating wires or the heating rods and the feeding end is, the larger the temperature of the group of heating wires or the temperature of the group of heating rods may be, so that a temperature of a preheating section may be distributed in a gradient.

It should be noted that a position of a last group of heating wires or heating rods of the softening heating module does not exceed a point of ½ of the feeding end of the preheating heating annealing furnace body 2.

In some embodiments of the present disclosure, the heat preservation layer and the refractory fiber adiabatic layer are disposed outside the preheating heating annealing furnace body 2, which may effectively reduce the loss of heat within the preheating heating annealing furnace body 2 and preserve heat for the preheating heating annealing furnace body 2. The cross-sectional area of the heat insulation plywood in the channel is adjusted, which may adjust the heat insulation effect. The heating state of each group of heating wires or the heating state of each group of heating rods is adjusted, so that the temperature of the preheating section in the channel is gradually increased, and a stable temperature is maintained in the heating section. The temperature change of gradient distribution can make the glass uniformly heated, which effectively avoids uneven drawing thickness or fracture caused by uneven heating of the glass.

In some embodiments, the preheating heating annealing furnace body 2 is provided with a furnace body temperature control device. The furnace body temperature control device may include a programmable proportion integration differentiation (PID) controller, an ammeter, a voltmeter, and a temperature-measuring thermocouple 22. As shown in FIG. 2, the temperature-measuring thermocouple 22 is distributed in a grid-like manner above the preheating section, the heating section, and the annealing section.

The furnace body temperature control device is configured to control a temperature inside the preheating heating annealing furnace body 2. The temperature-measuring thermocouple 22 refers to a thermocouple configured to measure temperatures of different regions of the preheating heating annealing furnace body 2. The programmable PID controller may be connected to the temperature-measuring thermocouple 22 in the grid-like manner to directly display a temperature measurement result of the temperature-measuring thermocouple 22 corresponding to the programmable PID controller.

In some embodiments of the present disclosure, the temperature-measuring thermocouple 22 distributed in a grid-like manner above the preheating section, the heating section, and the annealing section may monitor temperatures of different stages of the preheating heating annealing furnace body 2 in real time to determine temperature states of the glass when the glass is in the different sections. After a power supply of the preheating heating annealing furnace body 2 is turned on, a preheating target temperature and a softening target temperature are set by a control program, or a target temperature of a separate heating group is set by a control program, so that the temperature of the channel of the preheating heating annealing furnace body 2 may be gradually increased in the preheating section, maintained stable in the heating section, and slowly decreased in a gradient distribution in the annealing section, which helps to make the glass uniformly heated. The preheating target temperature refers to a temperature required for preheating in the process of preparing ultra-thin flexible glass. The softening target temperature refers to a temperature required for softening the glass in the process of preparing ultra-thin flexible glass. The separate heating group refers to a group of heating wires or heating rods. The target temperature refers to a temperature to be reached by the separate heating group in the process of preparing ultra-thin flexible glass. The edge clamping system 3 may be configured to clamp an edge of the glass in the heating section. As shown in FIG. 2, the edge clamping system 3 includes the first clamping device 31 and the second clamping device 32. The first clamping device 31 and the second clamping device 32 are each formed by the pressing bar 34 and the pressing bar support 35. The pressing bar support 35 is vertically connected to the pressing bar 34. The pressing bar support 35 is disposed at a furnace mouth of the preheating heating annealing furnace body 2.

The edge clamping system 3 includes an upper portion and a lower portion. The first clamping device 31 may be the upper portion of the edge clamping system 3, and the second clamping device 32 may be the lower portion of the edge clamping system 3. The upper portion is a portion of the edge clamping system 3 that is close to a furnace top of the preheating heating annealing furnace body 2. The lower portion is a portion of the edge clamping system 3 that is close to a furnace bottom of the preheating heating annealing furnace body 2.

The first clamping device 31 and the second clamping device 32 are each in a form of a clamp. The first clamping device 31 and the second clamping device 32 are each formed by a pressing bar 34 and a pressing bar support 35. The pressing bar 34 may be a bar-like structure. The pressing bar support 35 may be a plate-like structure vertically connected to the pressing bar 34. The pressing bar 34 may be configured to hold the glass. The pressing bar support 35 of the first clamping device 31 and the pressing bar support 35 of the second clamping device 32 may be disposed symmetrically with a longitudinal cross section of the preheating heating annealing furnace body 2 as an axis. The pressing bar support 35 is disposed at the furnace mouth, so that a position of the pressing bar support 35 may be adjusted easily. For example, the position of the pressing bar support 35 on the cross-section of the preheating heating annealing furnace body 2 may be adjusted according to a thickness of the raw glass sheet, and a position of the pressing bar 34 vertically connected to the pressing bar support 35 may be adjusted accordingly, so that the pressing bar 34 can be accurately attached to the raw glass sheet to achieve the clamping of the glass. The pressing bar support 35 is configured to support the pressing bar 34, and is also used as a furnace plug to block the furnace mouth to insulate for the preheating heating annealing furnace body 2.

In some embodiments, the rollers 33 are disposed above and below the pressing bar 34 of the edge clamping system 3. The rollers 33 are configured to transmit the glass, so that the edge clamping system 3 transmits the glass while clamping the glass.

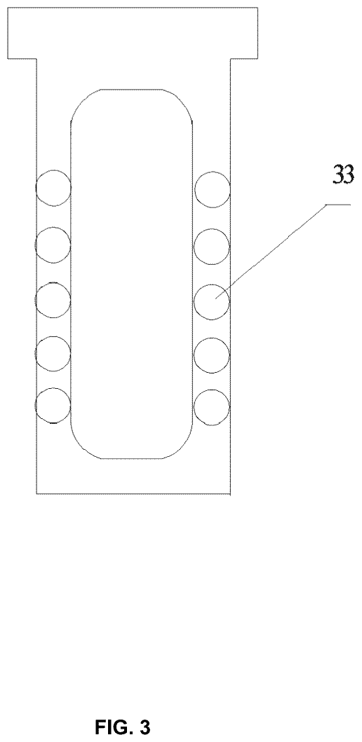

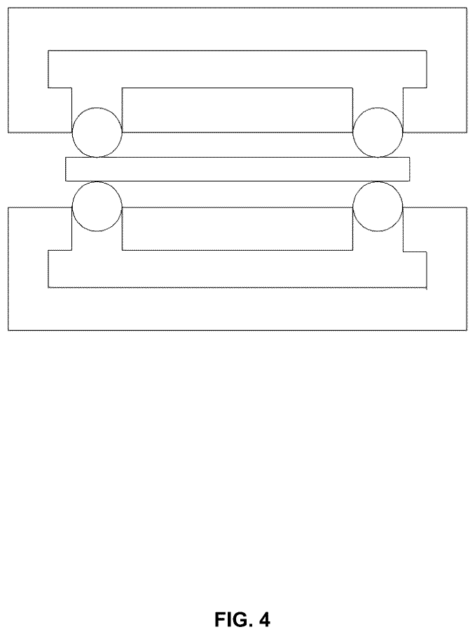

FIG. 3 is a sectional view of an edge clamping system according to some embodiments of the present disclosure. FIG. 4 is a schematic diagram illustrating an edge clamping system according to some embodiments of the present disclosure. As shown in FIGS. 3 and 4, the rollers 33 may be disposed below the pressing bar 34 corresponding to the first clamping device 31 and above the pressing bar 34 corresponding to the second clamping device 32 at the same time. The rollers 33 may transmit the glass while clamping the glass.

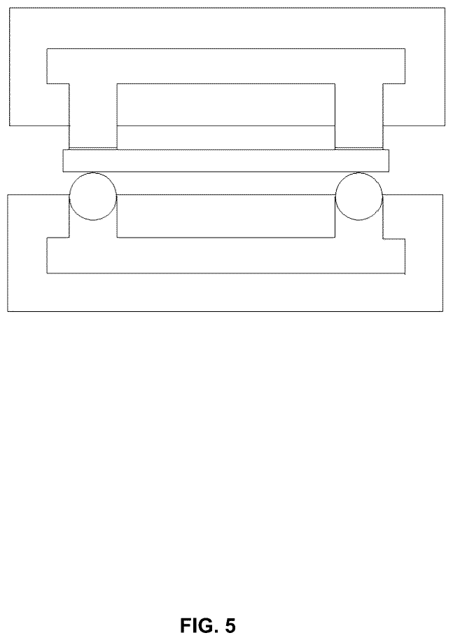

FIG. 5 is a schematic diagram illustrating another edge clamping system according to some embodiments of the present disclosure. As shown in FIG. 5, the pressing bar 34 of the first clamping device 31 may be not provided with the rollers 33. The rollers 33 may be disposed only above the lower pressing bar 34 (the pressing bar 34 of the second clamping device 32), thereby forming an edge clamping state of upper pressing and lower support transmission.

The pressing bar 34 of the first clamping device 31 and the pressing bar 34 of the second clamping device 32 enter through the furnace mouth, extend and cross a highest temperature drawing point, and coincide with a glass edge of the heating section. The highest temperature drawing point refers a position at which the glass at the highest temperature in the preheating heating annealing furnace body 2 is drawn. In some embodiments of the present disclosure, the pressing bar support 35 is disposed at the furnace mouth, which can insulate for the preheating heating annealing furnace body 2 while supporting the pressing bar 34. The rollers 33 may be disposed above and below the pressing bar 34, which may transmit the glass while clamping the glass.

In some embodiments, the edge clamping system 3 is further connected to an edge cooling device. The edge cooling device is configured to cool the edge clamping system 3.

In some embodiments, the edge cooling device is disposed at the pressing bar 34 of the edge clamping system 3. The edge cooling device may include a heat exchange and cooling device (e.g., a condenser, a cooler, etc.).

In some embodiments of the present disclosure, the edge cooling device is connected to the edge clamping system 3, which helps to clamp and shape the edge, overcome the contraction of the glass surface tension, and control the shrinkage of the glass plate width.

As shown in FIG. 1, the drawing system 4 is located on one side of the preheating heating annealing furnace body 2 near a discharging end. The drawing system 4 is configured to draw the glass. In some embodiments, the drawing system 4 is connected to an annealing port of the preheating heating annealing furnace body 2. The drawing system 4 includes a discharging end clamping device 41, a drawing motion guide rail 42, a drawing arm 43, and a tension drive 44. The discharging end clamping device 41 is disposed on the drawing motion guide rail 42. The discharging end clamping device 41 is connected to the drawing arm 43. The tension drive 44 acts on the drawing arm 43 to drive the glass clamped by the discharging end clamping device 41 through tension to draw the glass.

The discharging end clamping device 41 is configured to clamp the other end of the glass. The other end of the glass refers to an end of the glass that is not clamped by the feeding end clamping device 12. The two ends of the glass that are clamped by the discharging end clamping device 41 and the feeding end clamping device 12 are opposite ends. The drawing motion guide rail 42 refers to a guide rail where the discharging end clamping device 41 moves. The drawing arm 43 is configured to drive the glass clamped by the discharging end clamping device 41 to move along the drawing motion guide rail 42 based on the tension to realize the drawing of the glass. The tension drive 44 is configured to drive the drawing arm 43.

In some embodiments, the drawing motion guide rail 42 is provided with a scale, so that drawing displacement is determined, which facilitates adjusting a drawing rate.

In some embodiments, the tension drive 44 may control a tension magnitude of the drawing arm 43.

In some embodiments, the drawing system 4 may further include a limiter 45 and a tension sensor 46. The limiter 45 is located on the drawing arm 43 and moves with the drawing arm 43. The limiter 45 is configured to limit a moving speed of the drawing arm 43 on the drawing motion guide rail 42. The tension sensor 46 is located in the tension drive 44 and configured to monitor the tension of the drawing arm 43. In response to a determination that a tension change rate at a plurality of time points obtained by the tension sensor 46 meets a preset change condition, a movement of the drawing arm 43 is limited by the limiter 45. The plurality of time points may be located within a drawing cycle, and the preset change conditions of different drawing cycles may be different.

The limiter 45 refers to a device that limits a moving range or the moving speed of the drawing arm 43. In some embodiments, the limiter 45 is disposed at the drawing arm 43, moves with the drawing arm, and limits the moving speed of the drawing arm 43 on the drawing motion guide rail 42. The limiter 45 may limit the movement of the drawing arm 43. The limiter 45 may be disposed on the drawing arm 43, and the limiter 45 may be movably disposed in the drawing motion guide rail 42. When the tension change rate at the plurality of time points obtained by the tension sensor 46 meets the preset change condition, the limiter 45 may stop the movement, and the limiter 45 may be fixed in the drawing motion guide rail 42 to limit the movement of the drawing arm 43.

The tension sensor 46 refers to a sensor configured to measure the tension of the drawing arm 43. In some embodiments, the tension sensor 46 is disposed in the tension drive 44.

The preset change condition refers to a condition set in advance for determining whether to limit the movement of the drawing arm 43. For example, the preset change condition is that the tension change rate at the plurality of time points obtained by the tension sensor 46 exceeds a change threshold. The plurality of time points may be located within a single drawing cycle.

The drawing cycle refers to the time taken for the drawing arm 43 to be drawn to a maximum length. In some embodiments, the drawing cycle is a ratio of a length of the drawing arm 43 to a drawing rate.

The tension change rate refers to a change rate of tension corresponding to the plurality of time points. In some embodiments, the tension change rate is determined based on a statistical value of the change rates of tension corresponding to adjacent time points of the plurality of time points. For example, the tension change rate is an average or minimum value of the tension change rates corresponding to all adjacent time points, etc.

The change threshold may be set by the system or artificially. It should be noted that the preset change conditions and the change thresholds of different drawing cycles may be different. For example, the greater the thickness of the raw glass sheet is, and the greater the drawing rate is, the greater the corresponding change threshold may be.

In some embodiments, the change threshold is determined by querying a limit table. The limit table may include a correspondence between an average thickness of the raw glass sheet, a drawing rate, and a corresponding reference change threshold when the glass is fractured and abnormally deformed during historical drawing. A minimum value of the tension change rates at the plurality of adjacent time points in the drawing cycle corresponding to the time when the glass is fractured and abnormally deformed during historical drawing may be taken as the reference change threshold corresponding to the average thickness of the raw glass sheet and the drawing rate during the drawing process. The limit table may be constructed based on historical data. The change threshold corresponding to the current thickness of the raw glass sheet and a current drawing rate may be determined by querying the limit table.

In some embodiments of the present disclosure, the tension is monitored during production by the tension sensor 46, and the drawing arm 43 is limited to move through the limiter 45 when the tension change rate meets the preset change condition, which can avoid overdrawing, help to reduce the occurrence of an abnormal condition such as glass fracture, and ensure the normal operation of the drawing system, so as to facilitate the normal operation of the device for preparing ultra-thin flexible glass.

In some embodiments of the present disclosure, softened glass is drawn along the drawing motion guide rail 42 under the drive of the drawing arm 43, which helps to achieve control of the drawing rate by adjusting the tension magnitude of the drawing arm 43.

The laminating system 5 is configured to laminate the glass. As shown in FIG. 1, the laminating system 5 is disposed below the drawing system 4. In some embodiments, the laminating system 5 may be configured to electrostatically adsorb a film with a thickness of 0.1 mm-0.5 mm onto two surfaces of the glass.

In some embodiments, the film may be selected from a polyethylene film, a polypropylene film, a polyvinyl chloride film, or a polyester film to improve protection of the ultra-thin flexible glass and quality of the ultra-thin flexible glass.

In some embodiments of the present disclosure, the film may be electrostatically adsorbed onto the two surfaces of the glass by the laminating system 5, thereby accomplishing wrapping protection of the flexible glass surface.

The winding system 6 is configured to wind the laminated glass. As shown in FIG. 1, the winding system 6 is connected to a transmission device, the winding system 6 may wind the laminated glass, and the transmission device may be configured to transmit the glass.

The cutting system 7 is configured to cut the glass before winding. The cutting system 7 is disposed on a side of a transmission guide rail before the winding system 6 and is configured to cut the glass before winding.

In some embodiments, the cutting system 7 may include a cutting knife, a cutting knife drive, and a cutting and dust removal device. The cutting knife drive is configured to drive the cutting knife to cut the glass, and the cutting and dust removal device is configured to clean impurity dust generated during cutting. In some embodiments, the cutting system 7 may also include laser cutting.

In some embodiments of the present disclosure, the cutting is accomplished through the cutting system 7 after the ultra-thin flexible glass is packaged by a roll and before winding, and at the same time, the dust is removed, thereby ensuring the quality of the ultra-thin flexible glass.

In some embodiments, the device for preparing ultra-thin flexible glass may further include an online monitoring system. The online monitoring system refers to a system that measures changes in the width and thickness of the ultra-thin flexible glass in real time through laser or spectral sensing.

In some embodiments, a preheating temperature of the glass may be within a range of 580° C.-800° C. A heating drawing temperature may be within a range of 700° C.-1080° C.

In some embodiments, a feeding rate of the feeding system 1 may be within a range of 10 mm/min-60 mm/min. The drawing rate of the drawing system 4 may be within a range of 300 mm/min-1200 mm/min.

In some embodiments, the thickness of the ultra-thin flexible glass product may be within a range of 20 μm-90 μm with a tolerance of ±2 μm.

Some embodiments of the present disclosure provide the device for preparing ultra-thin flexible glass. The preheating heating annealing furnace body 2 may include the preheating section, the heating section, and the annealing section. The gradient temperature control in the channel is achieved by relying on the temperature setting of the furnace body heating device, so that the glass temperature change is more compact. The temperature-measuring thermocouple 22 of the preheating heating annealing furnace body is designed in the grid-like manner, which clarifies temperature points of glass blocks and facilitates temperature adjustment, so that the glass is uniformly heated, the fracture of the glass caused by uneven heating, uneven drawing thickness of the glass, or uneven heating and cooling are avoided, thereby ensuring the glass drawing utilization rate, and in particular, enhancing the utilization rate of the glass plate of uneven thickness. The clamping device clamps two ends of the glass. The glass is drawn at the discharging end and fed at the feeding end, thereby forming a continuous drawing with feeding and drawing. When the glass is drawn to an extreme degree, the discharging end clamping device releases and moves back to an initial position along the guide rail to clamp the glass, thereby forming a reciprocating movement of the tension drive, so as to realize the continuous drawing preparation. The edge clamping device insulates at the furnace mouth of the feeding end, the glass edge in the drawing section is maintained at a pressing and clamping state, and the edge is cooled to overcome the contraction of the tension of the glass surface and control the reduction of the glass plate width. The overall horizontal setting of the furnace body and the drawing device is not limited by the height of the plant, which avoids high-level operation.

In some embodiments, a method for preparing ultra-thin flexible glass may be implemented by the device for preparing ultra-thin flexible glass. The method includes: loading the raw glass sheet into the channel of the preheating heating annealing furnace body, clamping the raw glass sheet by the edge clamping system, preheating the loaded raw glass sheet in the preheating heating annealing furnace body; transmitting the raw glass sheet to the heating section when a preheating temperature is reached, evenly heating the preheated raw glass sheet to a drawing temperature for softening; drawing the softened glass in the drawing system; annealing the drawn glass and transmitting the annealed glass to the laminating system for laminating; and transmitting the laminated glass into the winding system for packing; and transmitting the packaged glass into the cutting system for rolling according to a fixed roll size. More descriptions regarding the device for preparing ultra-thin flexible glass and components thereof may be found in the related descriptions of FIGS. 1-5.

In some embodiments, the raw glass sheet may be loaded into the channel of the preheating heating annealing furnace body. One end of the raw glass sheet is clamped by the feeding end clamping device, and the other end of the raw glass sheet is clamped by the discharging end clamping device. The raw glass sheet refers to glass used as raw material for preparing ultra-thin flexible glass. The raw glass sheet is clamped by the edge clamping system, and the loaded raw glass sheet is preheated in the preheating heating annealing furnace body.

The raw glass sheet is preheated by the preheating heating annealing furnace body, when the preheating temperature is reached, the raw glass sheet is transmitted to the heating section to evenly heat to a drawing temperature for softening. In some embodiments, the preheating temperature may be within a range of 580° C.-800° C. The heating drawing temperature may be within a range of 700° C.-1080° C.

The softened glass is drawn in the drawing system. In some embodiments, the tension drive is loaded, and the softened glass is driven by traction of the tension drive to move along the drawing motion guide rail to achieve drawing.

In some embodiments, the drawn glass is annealed precisely in the annealing section of the preheating heating annealing furnace body and transmitted to the laminating system for suspension, and the annealed glass is laminated when the rollers of the laminating system transmit the film to the surface of the glass.

The laminated glass may be transmitted into the winding system for package.

The packaged glass may be transmitted into the cutting system. The cutting system may cut the glass according to the fixed roll size, and the rolling may be completed after the cutting.

In some embodiments, the method for preparing ultra-thin flexible glass may be performed by a processor. The processor is configured to process information and/or data related to the method for preparing ultra-thin flexible glass. In some embodiments, the processor may process data, information, and/or processing results obtained from other devices or system components and execute, based on the data, information, and/or processing results, program instructions to perform one or more functions described in the present disclosure.

In some embodiments, the processor may generate, based on raw glass sheet thickness data obtained by a thickness monitoring device, thickness sequence data corresponding to the raw glass sheet; and control, based on the thickness sequence data, a thickness of the drawn glass by regulating a drawing parameter of the drawing system.

The thickness monitoring device refers to a device that monitors the thickness of glass. For example, the thickness monitoring device may include a laser component, an infrared component, etc.

The raw glass sheet thickness data refers to thickness data of the raw glass sheet before drawing. In some embodiments, the processor may obtain the raw glass sheet thickness data via the thickness monitoring device. More descriptions regarding the raw glass sheet may be found in the related descriptions.

The thickness sequence data refers to a sequence consisting of raw glass sheet thickness data of a raw glass sheet at different lengths in a drawing cycle. For example, if the thickness of the raw glass sheet A is 0.9 cm at a length of 1 cm, the thickness of the raw glass sheet A is 1.0 cm at a length of 2 cm, and the thickness of the raw glass sheet A is 1.1 cm at a length of 3 cm, the thickness sequence data of the raw glass sheet A may be (1, 0.9; 2, 1.0; 3, 1.1). More descriptions regarding the drawing cycle may be found in the related descriptions. The processor may sequentially construct all raw glass sheet thickness data monitored by the thickness monitoring device during a drawing cycle and glass lengths corresponding to all raw glass sheet thickness data into thickness sequence data corresponding to the drawing cycle.

In some embodiments, a data amount of the thickness sequence data may be determined in various ways.

For example, the data amount of the thickness sequence data may be a value preset by a user. As another example, the processor may determine the data amount of the thickness sequence data based on the feeding rate. The greater the feeding rate is, the greater the data amount of the thickness sequence data may be, and the greater the frequency at which the thickness monitoring device monitors the thickness of the glass may be.

In some embodiments, the data amount of the thickness sequence data may also be related to a uniform value of the thickness of the drawn glass that is actually monitored subsequently.

The uniform value of the thickness is a degree of uniformity of the thickness of the drawn glass that is actually monitored subsequently. The uniform value of the thickness may be a value between 0 and 1. The greater the uniform value of the thickness is, the more consistent the thickness data of the drawn glass may be.

In some embodiments, the processor may monitor the drawn glass based on the thickness monitoring device, obtain thickness data of the drawn glass at different positions; and determine, based on the thickness data of the drawn glass at different positions, the uniform value of the thickness. If the thickness data of the drawn glass at the different positions is consistent, the uniform value of the thickness is 1. If the thickness data of the drawn glass at different positions is inconsistent, the processor determines, based on the thickness data of the drawn glass at different positions, a maximum difference of the thickness and an average of the thickness, and determines, based on the maximum difference of the thickness and the average of the thickness, the uniform value of the thickness. The maximum difference of the thickness refers to a difference between a maximum value of the thickness data and a minimum value of the thickness data of the thickness data of the drawn glass at the different positions. The average of the thickness refers to an average of the thickness data of the drawn glass at the different positions. The processor may determine (1−a ratio of the maximum difference of the thickness to the average of the thickness) as the uniform value of the thickness.

In some embodiments, the smaller the uniform value of the thickness is, the greater the data amount of the thickness sequence data is.

In some embodiments, the processor may determine a monitoring frequency of the thickness monitoring device based on the uniform value of the thickness and determine the data amount of the thickness sequence data.

In some embodiments, the processor may determine, based on the uniform value of the thickness, the monitoring frequency of the thickness monitoring device by querying a monitoring table. The monitoring table includes reference monitoring frequencies corresponding to different uniform values of the thickness. The monitoring table may be constructed based on historical data. For example, the processor may determine a minimum value of historical monitoring frequencies as a reference monitoring frequency corresponding to the uniform value of the thickness when the uniform value of thickness corresponding to different historical monitoring frequencies satisfies a uniformity condition. The uniformity condition refers to a condition of the uniform value of the thickness that the user requires to be reached, for example, the uniformity condition may be that the uniform value of the thickness exceeds a uniformity threshold. The uniformity threshold may be set by the system or artificially.

The greater the monitoring frequency of the thickness monitoring device is, the greater the data amount of the thickness sequence data corresponding to the thickness monitoring device may be.

In some embodiments of the present disclosure, the data amount of the thickness sequence data may be adjusted based on the uniform value of the thickness, which reduces the monitoring cost while ensuring that the monitoring frequency is sufficient.

The drawing parameter refers to a parameter related with drawing glass. In some embodiments, the drawing parameter may include a drawing speed, tension, etc.

In some embodiments, the processor may regulate the drawing parameter of the drawing system based on the thickness sequence data in various ways.

For example, the processor may construct a vector database based on the historical data, construct a vector to be matched based on current thickness sequence data and a current feeding rate. In the vector database, the processor may retrieve a matching vector that is similar to the vector to be matched and determine a reference drawing parameter corresponding to the matching vector or an average of a plurality of reference drawing parameters as the drawing parameter corresponding to the current thickness sequence data. The vector database may include a plurality of matching vectors consisting of historical thickness sequence data and historical feeding rate and reference drawing parameters corresponding to the matching vectors. In some embodiments, the reference drawing parameter may be a historical drawing rate corresponding to a thickness meeting a need of the user of the thickness of the drawn glass monitored subsequently of the historical data. The thickness meeting the need of the user may be a uniform value of the thickness meeting the uniformity condition, etc. The vector database may be constructed based on historical data. In some embodiments, the matching vector that is similar to the vector to be matched may be a vector whose similarity satisfies a similarity threshold, etc. The similarity may include Euclidean distance, cosine similarity, etc.

In some embodiments, the processor may determine, based on thickness data of each raw glass sheet of the thickness sequence data, a plurality of candidate drawing parameters, and determine, based on a drawing model and the candidate drawing parameters, a drawing parameter.

In some embodiments, the drawing model may be a machine learning model. For example, the drawing model may include a deep neural network (DNN), etc.

In some embodiments, an input of the drawing model may include a feeding rate, thickness sequence data, a monitored drawing temperature, and the candidate drawing parameter. An output of the drawing model may be a predicted uniform value of thickness.

The monitored drawing temperature refers to a glass drawing temperature that is actually monitored during drawing. The monitored drawing temperature may be obtained based on a temperature-measuring thermocouple. More descriptions regarding the temperature-measuring thermocouple may be found in the related descriptions of FIG. 2.

The candidate drawing parameter refers to a candidate value of the drawing parameter.

In some embodiments, the processor may determine, based on the thickness data of each raw glass sheet of the thickness sequence data, at least one reference drawing parameter as a first candidate parameter by retrieving from a vector database, determine, based on the first candidate parameter, a second candidate parameter by interpolation, and determine the candidate drawing parameter based on the first candidate parameter and the second candidate parameter.

In some embodiments, the processor may determine the first candidate parameter by retrieving from the vector database. More descriptions regarding the vector database and the retrieval thereof may be found in the related descriptions.

In some embodiments, the processor may determine, based on the first candidate parameter, the second candidate parameter by interpolation. For example, the processor may determine an average of adjacent first candidate parameters as the second candidate parameter. For example, if the processor determines the first candidate parameter to be 300, 500, and 600 by querying the vector database, the processor may determine, based on the first candidate parameter, the second candidate parameter to be 400, 350, 450, and 550 as the second candidate parameter by interpolation.

In some embodiments, the processor may determine both the first candidate parameter and the second candidate parameter as the candidate drawing parameters.

In some embodiments, the drawing model may be obtained by training based on a plurality of training samples with labels. The processor may obtain the drawing model by performing the following training process. The training process includes obtaining the plurality of training samples with labels to form a training sample set and performing, based on the training sample set, a plurality of rounds of iteration. At least one round of iteration includes selecting one or more training samples from the training data set and obtaining one or more model prediction outputs corresponding to the one or more training samples by inputting the one or more training samples into an initial drawing model, calculating, by substituting the one or more model prediction outputs corresponding to the one or more training samples and training labels corresponding to the one or more training samples into a predefined loss function, a value of the loss function, iteratively updating model parameters of the initial drawing model according to the value of the loss function until an iteration end condition is satisfied, and obtaining a trained drawing model. The model parameters of the initial drawing model may be iteratively updated in various ways, for example, the model parameters may be updated based on a gradient descent manner. The iteration end condition may include the loss function converging or a count of iterations reaching a threshold of the count of iterations, etc. A set of training samples for training the drawing model may include sample feeding rate, sample thickness sequence data, sample monitored drawing temperature, and sample candidate drawing parameter. The training labels corresponding to the set of training samples may be the uniform values of the thickness actually corresponding to the training samples.

The training samples may be obtained based on historical data. The training labels may be obtained in a way same as a way in which the uniform values of the thickness are obtained, which may be found in the descriptions of the uniform values of the thickness. In some embodiments, when a plurality of same training samples correspond to different uniform values of the thickness, the training labels may be an average of the different uniform values of the thickness.

In some embodiments, when the plurality of same training samples correspond to the different uniform values of the thickness, the processor may determine valid samples based on a standard deviation of the different uniform values of the thickness. For example, if the standard deviation of the different uniform values of the thickness is smaller than a preset standard deviation threshold, the plurality of training samples may be the valid samples. If the standard deviation of the different uniform values of the thickness is greater than or equal to the preset standard deviation threshold, the plurality of training samples may be invalid samples and not be used in the training of the drawing model. The preset standard deviation threshold may be preset by the system or artificially.

In some embodiments, the processor may determine a candidate drawing parameter corresponding to a maximum predicted uniform value of the thickness output by the drawing model as a drawing parameter for regulating the drawing system.

In some embodiments of the present disclosure, the candidate drawing parameter is determined based on the thickness data of each raw glass sheet of the thickness sequence data, and the drawing parameter is determined by the drawing model, which improves the accuracy of the drawing parameter, so as to facilitate effective control of the thickness of the drawn glass.

In some embodiments of the present disclosure, the drawing parameter is regulated by monitoring the difference of thickness of different regions of the raw glass sheet, which effectively ensures the uniformity of the thickness of the subsequently drawn glass, thereby ensuring the production quality.

In some embodiments, the processor may pre-regulate, based on the thickness sequence data, target temperatures of different regions of the preheating heating annealing furnace body through separate heating groups in the preheating heating annealing furnace body.

More descriptions regarding the separate heating group may be found in the descriptions about the furnace body temperature control device.

The different regions of the preheating heating annealing furnace body refer to different heating coverage regions of the separate heating groups. The target temperatures refer to temperatures that need to be reached in the different regions of the preheating heating annealing furnace body in the process for preparing ultra-thin flexible glass.

In some embodiments, the processor may pre-regulate, based on the thickness sequence data, the target temperatures of the different regions of the preheating heating annealing furnace body through the separate heating groups in the preheating heating annealing furnace body in various ways. For example, the larger the raw glass sheet thickness data of the thickness sequence data is, the higher the target temperature corresponding to a region in which the raw glass sheet thickness data is located may be.

In some embodiments, the processor may regulate the target temperatures of different regions of the preheating heating annealing furnace body by adjusting a cross-sectional area of the heat insulation plywood.

In some embodiments, the processor may adjust the cross-sectional area of the heat insulation plywood based on the uniform value of the thickness. For example, the processor may reduce the cross-sectional area of the heat insulation plywood in the preheating heating annealing furnace body when the uniform value of the thickness is relatively small.

In some embodiments, the processor may determine a product of an original cross-sectional area of the heat insulation plywood between the preheating section and the heating section and a maximum uniform value of the thickness output by the drawing model as an adjusted cross-sectional area of the heat insulation plywood. More description on the drawing model may be found in the related descriptions.

In some embodiments, the processor may determine a product of the original cross-sectional area of the heat insulation plywood between the preheating section and the heating section and an actually monitored uniform value of the thickness as the adjusted cross-sectional area of the heat insulation plywood.

In some embodiments of the present disclosure, the processor may regulate the target temperatures of different regions of the preheating heating annealing furnace body by adjusting the cross-sectional area of the heat insulation plywood, which effectively avoids a relatively drastic temperature change, thereby reducing the occurrence of the fracture of the glass.

In some embodiments, an overall heating power of the preheating heating annealing furnace body is related to a uniform value of a thickness of the drawn glass that is actually monitored subsequently.

The overall heating power refers to a comprehensive heating power of the preheating heating annealing furnace body.

In some embodiments, the overall heating power of the preheating heating annealing furnace body is related to the uniform value of the thickness of the drawn glass that is actually monitored subsequently. For example, the greater the uniform value of the thickness is, the smaller the overall heating power is.

For example, the processor may obtain an adjusted overall heating power according to equation (1)

$${P}_{1} = {P}_{0} \times ( 1 - T ) . \qquad ( 1 )$$

In the equation, P₁ denotes the adjusted overall heating power, P₀ denotes a basic heating power, and T denotes the uniform value of the thickness.

The basic heating power refers to an initial overall heating power of the preheating heating annealing furnace body. In some embodiments, the basic heating power may be preset by the user.

In some embodiments, the processor may determine heating powers of the separate heating groups based on the adjusted overall heating power and regulate the target temperatures of the different regions in the preheating heating annealing furnace body.

In some embodiments, the greater the thickness of the raw glass sheet in a region corresponding to the separate heating group is, the greater the heating power of the separate heating group is. The processor may regulate the heating power of each separate heating group based on the following equation (2) to pre-regulate the target temperatures of the different regions in the preheating heating annealing furnace body.

$${P}_{2} = {P}_{1} \times a / b . \qquad ( 2 )$$

In equation (2), P₂ denotes the heating power of the separate heating group, a denotes the thickness of the raw glass sheet in the region corresponding to the separate heating group, and b denotes an average thickness of the raw glass sheet.

In some embodiments of the present disclosure, the cross-sectional area of the heat insulation plywood in the preheating heating annealing furnace body is adjusted based on the uniform value of the thickness of the raw glass sheet, which ensures that the temperature difference of the different heating regions is in a normal production range and guarantees the production quality.

In some embodiments of the present disclosure, when the thickness of the raw glass sheet is not uniform, the overly drastic heating may lead to problems such as fracture and burst of the raw glass sheet due to the uneven force. By obtaining the distribution of the thickness of different regions of the raw glass sheet, the overall heating power and local heating power of the heating wires or heating rods at different positions in the preheating heating annealing furnace body are reasonably regulated, which ensures the uniformity and stability of heating and improves the production quality.

In some embodiments of the present disclosure, the process for preparing ultra-thin flexible glass implemented based on the device for preparing ultra-thin flexible glass is simple. The device for preparing ultra-thin flexible glass is easy to maintain, and it is convenient to adjust the temperature, the feeding rate, the drawing rate, the tension, etc., which can be used to prepare ultra-thin flexible glass of different thicknesses using a plurality of glass plates such as alkali-containing high-aluminum silicate, alkali-containing medium-aluminum silicate, alkali-free silicate, etc.

The parameters of Embodiments 1-8 and the parameters of the glass products obtained according to the method are shown in Table 1.

TABLE 1
Parameters of Embodiments 1-8 and parameters of the obtained glass products

| Parameter | Embodiment 1 | Embodiment 2 | Embodiment 3 | Embodiment 4 | Embodiment 5 | Embodiment 6 | Embodiment 7 | Embodiment 8 |
|---|---|---|---|---|---|---|---|---|
| Thickness | 700 | 700 | 500 | 510 | 480 | 490 | 800 | 800 |
| of raw glass | | | | | | | | |
| sheet (cm) | | | | | | | | |
| Preheating | 800 | 800 | 760 | 760 | 760 | 760 | 620 | 620 |
| temperature | | | | | | | | |
| (° C.) | | | | | | | | |
| Drawing | 980 | 1030 | 870 | 890 | 910 | 930 | 800 | 850 |
| temperature | | | | | | | | |
| (° C.) | | | | | | | | |
| Annealing | 720 | 720 | 670 | 670 | 670 | 670 | 586 | 586 |
| temperature | | | | | | | | |
| (° C.) | | | | | | | | |
| Feeding rate | 40 | 30 | 15 | 15 | 20 | 25 | 30 | 50 |
| (mm/min) | | | | | | | | |
| Drawing rate | 653 | 906 | 447 | 583 | 650 | 804 | 1042 | 1161 |
| (mm/min) | | | | | | | | |
| Thickness after | 78 | 28 | 83 | 69 | 46 | 37 | 89 | 67 |
| drawing (μm) | | | | | | | | |

It should be noted that a manner for preparing the glass base material is not limited, which includes a manner for preparing flat glass (e.g., float process, overflow drawing process, roll forming process, etc.). Moreover, the preparation device may be used in conjunction with the preparation of glass base material. Taking the overflow drawing process as an example, the glass formed through the overflow drawing process continues to be fed into the preparation device and the method for preparing ultra-thin flexible glass is connected to the process for preparing glass base material, which forms a continuous preparation of ultra-thin flexible glass.

Although the embodiments of the present disclosure are described above in conjunction with the drawings, the present disclosure is not limited to the specific embodiments and fields of application as described above. The specific embodiments described above are merely illustrative, instructive, and not limiting. Under the inspiration of the specification, those skilled in the art can also make many forms without departing from the scope of protection of the claims of the present disclosure, which all belong to the protection of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A device for preparing ultra-thin flexible glass, comprising a preheating heating annealing furnace body, wherein the preheating heating annealing furnace body is provided with a feeding system and a drawing system on both sides, an edge clamping system is disposed from a feeding port to a middle of the preheating heating annealing furnace body, and the drawing system is successively connected with a laminating system, a winding system, and a cutting system, wherein
the edge clamping system includes a first clamping device and a second clamping device, the first clamping device and the second clamping device are each formed by a pressing bar and a pressing bar support, the pressing bar support is vertically connected to the pressing bar, the pressing bar support is disposed at a furnace mouth of the preheating heating annealing furnace body, and rollers are disposed above and below the pressing bar.

2. The device of claim 1, wherein the feeding system includes a feeding drive, a feeding end clamping device, and a feeding guide rail, the feeding drive being connected to one side of the feeding guide rail, and the feeding end clamping device being located on the feeding guide rail.

3. The device of claim 1, wherein a central position of the preheating heating annealing furnace body is in a form of a channel, two ends of the preheating heating annealing furnace body are respectively connected to a feeding end and a discharging end, a preheating section, a heating section, and an annealing section are disposed inside the preheating heating annealing furnace body, a heat insulation plywood is respectively disposed between the preheating section and the heating section and between the heating section and the annealing section, and a cross-sectional area of the heat insulation plywood is adjustable.

4. The device of claim 3, wherein a heat preservation layer and a refractory fiber adiabatic layer are disposed outside the preheating heating annealing furnace body.

5. The device of claim 3, wherein the preheating heating annealing furnace body is provided with a furnace body heating device, the furnace body heating device includes a preheating heating module and a softening heating module, and the preheating heating module and the softening heating module are respectively provided with a plurality of groups of heating wires or heating rods.

6. The device of claim 1, wherein the preheating heating annealing furnace body is provided with a furnace body temperature control device, the furnace body temperature control device includes a programmable proportion integration differentiation (PID) controller, an ammeter, a voltmeter, and a temperature-measuring thermocouple, and the temperature-measuring thermocouple is distributed in a grid-like manner above a preheating section, a heating section, and an annealing section.

7. The device of claim 1, wherein the drawing system is connected to an annealing port of the preheating heating annealing furnace body, the drawing system includes a discharging end clamping device, a drawing motion guide rail, a drawing arm, and a tension drive, the discharging end clamping device is disposed on the drawing motion guide rail, the discharging end clamping device is connected to the drawing arm, and the tension drive acts on the drawing arm to drive glass clamped by the discharging end clamping device through tension, to draw the glass.

8. The device of claim 7, wherein the drawing system further includes a limiter and a tension sensor, the limiter is located on the drawing arm and moves with the drawing arm, the limiter is configured to limit a moving speed of the drawing arm on the drawing motion guide rail, and the tension sensor is located in the tension drive and is configured to monitor the tension of the drawing arm.

9. The device of claim 8, wherein the limiter is further configured to:
in response to a determination that a tension change rate of a plurality of time points obtained by the tension sensor meets a preset change condition, stop moving to limit the drawing arm.

10. The device of claim 1, wherein the laminating system is configured to electrostatically adsorb a film with a thickness of 0.1 mm-0.5 mm onto two surfaces of glass.

11. The device of claim 10, wherein the film is selected from a polyethylene film, a polypropylene film, a polyvinyl chloride film, or a polyester film.

12. The device of claim 1, wherein the cutting system includes a cutting knife, a cutting knife drive, and a cutting and dust removal device.

13. The device of claim 1, wherein the edge clamping system is further connected to an edge cooling device.

14. A method for preparing ultra-thin flexible glass, performed based on the device for preparing ultra-thin flexible glass of claim 1, comprising:
loading a raw glass sheet into the channel of the preheating heating annealing furnace body, clamping the raw glass sheet by the edge clamping system, preheating the loaded raw glass sheet in the preheating heating annealing furnace body;
transmitting the raw glass sheet to the heating section when a preheating temperature is reached, evenly heating the preheated raw glass sheet to a drawing temperature for softening;
drawing the softened glass in the drawing system;
annealing the drawn glass and transmitting the annealed glass to the laminating system for laminating; and
transmitting the laminated glass into the winding system for package; and
transmitting the packaged glass into the cutting system for rolling according to a fixed roll size.

15. The method of claim 14, performed by a processor, comprising:
generating, based on raw glass sheet thickness data obtained by a thickness monitoring device, thickness sequence data corresponding to the raw glass sheet; and
controlling, based on the thickness sequence data, a thickness of the drawn glass by regulating a drawing parameter of the drawing system.

16. The method of claim 15, wherein a data amount of the thickness sequence data is related to a uniform value of the thickness of the drawn glass that is monitored subsequently.

17. The method of claim 16, comprising:
determining, based on thickness data of each raw glass sheet of the thickness sequence data, a candidate drawing parameter, the candidate drawing parameter being an input of a drawing model, the drawing model being a machine learning model, and the drawing model being configured to determine the drawing parameter, wherein
the determining a candidate drawing parameter includes:
determining, based on the thickness data of each raw glass sheet of the thickness sequence data, at least one reference drawing parameter as a first candidate parameter by retrieving from a vector database;
determining, based on the first candidate parameter, a second candidate parameter by interpolation; and
determining the candidate drawing parameter based on the first candidate parameter and the second candidate parameter.

18. The method of claim 14, performed by a processor, comprising:
pre-regulating, based on thickness sequence data, target temperatures of different regions of the preheating heating annealing furnace body through separate heating groups in the preheating heating annealing furnace body.

19. The method of claim 18, wherein the pre-regulating target temperatures of different regions in the preheating heating annealing furnace body includes:
regulating the target temperatures of different regions in the preheating heating annealing furnace body by adjusting a cross-sectional area of the heat insulation plywood.

20. The method of claim 19, wherein an overall heating power of the preheating heating annealing furnace body is related to a uniform value of a thickness of the drawn glass that is monitored subsequently.
